(19) United States
(12) Patent Application Publication
(10) Pub. No.: US 2007/0028538 A1
(43) Pub. Date: Feb. 8, 2007

(54) Glazing system

(75) Inventor: Dietmar Woelfert, Titterten (CH)

Correspondence Address: HARNESS, DICKEY & PIERCE, P.L.C., P.O. BOX 828, BLOOMFIELD HILLS, MI, 48303, US

(73) Assignee: Clad Engineering

(21) Appl. No.: 11/496,761

(22) Filed: Aug. 1, 2006

(30) Foreign Application Priority Data
Aug. 2, 2005 (DE) 20 2005 012 108.8

(51) Int. Cl. E06B 1/04

(52) U.S. Cl. 52/204.1

(57) ABSTRACT

The present invention relates to a system for the frameless fixation of an insulating glass unit having two panes connected to each other by a rim connection having a groove in which a fixation element engages. The rim connection of the insulating glass unit consists of a preferably metallic spacer profile which is located between two panes that are essentially parallel to each other. On the outer face of the spacer profile a sealing matter, usually made of silicon, is placed, which assures a constant connection of the two panes, on the one hand, and an air-tight or gas-tight closing of the insulating glass unit, on the other hand. A groove is formed in this sealing matter belonging to the rim connection, on the outer face of the insulating glass unit. When the insulating glass unit has been mounted, the groove is advantageously not visible for an observer, since it is covered by the sealing matter as well as by the spacer profile.

### BACKGROUND OF THE INVENTION

1. Technical Field

The present invention relates to a system for the preferably frameless fixation of an insulating glass unit comprising two panes connected to each other by means of a rim connection at buildings or the like.

2. Discussion

Glazings of outer and inner building facades are generally known in the state of the art. The use of highly portative adhesives, such as for example silicon adhesives, has enabled frameless glazing systems. These ones have been worldwide adopted in the construction of multi-story buildings due to their simpleness and the easy maintenance. Different methods are known from the state of the art, by means of which such frameless glazings are fixed at buildings.

In a known system, an insulating glass unit is directly glued with its pane on the building side to a base frame arranged at the building. The base frame is generally made of aluminium or stainless steel, which means for the conglutination of the pane that adhesives have to be used which highly adhere both on glass and on metal surfaces. These adhesives are disadvantageously expensive. The conglutination of the glazing and the base frame can be directly realised by the manufacturer of the glazing, on the one hand, such that the base frames have to be disadvantageously supplied to this one which causes additional costs. If the conglutination is carried out by the facade constructor or directly on the building site, on the other hand, the equipment required for this has to be located in special localities. This is very complicate and leads to more high costs. Furthermore, the conglutination of the glazing with the base frame has to be carried out very precisely in order to assure the impeccable quality thereof. In case of a failure of the conglutination between base frame and glazing, which can be caused by great heat for example in the case of fire, the entire glazing can disengage from the base frame and fall down. Often, glazings have to meet the regulations for the prevention of falling down. But a 100% guarantee against a failure of the conglutination cannot be given in every case. Therefore, the glazings are partially forbidden by building laws or have to be completed by additional metallic safety units against falling down, which adversely influence the visual appearance of the facade and lead to additional costs.

Furthermore it is known from the state of the art to provide the glazing in form of a stepped insulating glass unit. Herein, the pane opposite the building side is greater than the pane facing the building. A base frame made of aluminium or stainless steel is glued into the step that has been created in this way at the rim of the glass unit. The problems related to this conglutination have already been described above. The conglutination of the base frame with the glazing unit has a higher strength due to the L-form thereof than the conglutinations described above, but the base frame that is directly connected to the outer pane via the adhesive forms a thermal bridge, whereby the U value of this glass frame combination gets considerably worse.

It is furthermore known from the state of the art to get the insulating glass unit jammed with respect to the facade by means of a holding device fixed at the facade. For this purpose, the holding device engages in the space between the panes of the insulating glass unit and gets the inner pane facing the facade jammed with this one. Hereby, high tensions are caused in the pane. Furthermore, an additional elastic interlayer might eventually be required between the insulating glass unit and the facade. Due to the high induced tensions the inner pane facing the facade must have a correspondingly thick cross section, which causes higher costs and the glazing unit disadvantageously gets a high weight.

The entire connection obtained by means of the holding device and the interlayer must be designed such that building deformations and thermal extensions can be received, will not be transferred to the glazing unit and nevertheless a safe fixation will be assured. This highly limits the usability of such systems and leads to wide joints between adjacent glazing units, which can only be finished after a completed mounting of all glazing units. This finishing is disadvantageously dependent on the weather and leads to higher assembly costs. A pre-fabrication of entire facade elements by a company that manufactures facade elements is not possible.

Finally glazing systems are known from the state of the art, in which the rim connection of an insulating glass unit is provided with special spacers which present a receiver for a holding element to be fixed at the fagade. The manufacture of such insulating glass units having special spacers is disadvantageously expensive and complex. Furthermore, the insulating glass spacer disadvantageously forms a thermal bridge which leads to a worsening of the U-value of the glazing. The holding device engaging into the spacer is an essentially L-shaped element, by means of which a rigid connection between facade and glazing unit is formed. Therefore, additional measures are required in order to be able to avoid an induction of too high tensions into the glass and not to introduce building deformations and thermal extensions into the glazing unit. Due to the use of the rigid holding devices, the joints that are present between adjacent glazing units are extremely wide. The separate post-treatment thereof causes correspondingly high costs. A pre-fabrication of entire facade elements is not possible.

### SUMMARY OF THE INVENTION

Based on the described state of the art it is the object of the present invention to provide a system for the preferably frameless fixation of a glazing at buildings and the like, which avoids bearing conglutinations between metal and glass surfaces, which enables a mechanical fixation of the glazing unit at the building with a high safety, in particular with horizontal working loads for the purpose of preventing a falling down, which largely avoids the formation of thermal bridges that lead to a reduction of the U-value and to energy losses, and which can furthermore be used in a highly flexible way with other glazing systems, in particular with glazing systems having frames that are visible from outside.

This aim is achieved by the invention in that it proposes a system for the preferably frameless fixation of an insulating glass unit comprising two panes connected to each other by means of a rim connection at buildings or the like, that is wherein the insulating glass unit is mounted on the building by means of a fixation element that engages into a groove formed in the rim connection of the insulating glass unit.

The rim connection of the insulating glass unit consists of a preferably metallic spacer profile which is located between two panes that are essentially parallel to each other. On the outer face of the spacer profile a sealing matter, usually made of silicon, is placed, which assures a constant connection of the two panes, on the one hand, and an air-tight or gas-tight closing of the insulating glass unit, on the other hand. A groove is formed in this sealing matter belonging to the rim connection, on the outer face of the insulating glass unit. When the insulating glass unit has been mounted, the groove is advantageously not visible for an observer, since it is covered by the sealing matter as well as by the spacer profile. Practically, the groove is formed in the rim connection by the manufacturing company during the manufacture of the insulating glass unit. In this way, the insulating glass unit can be directly mounted by means of the system according to the invention in the workshop or on the building site without using additional tools or supplementary working operations. The insulating glass unit is mounted in that the fixation element is placed and fixed on the building, on the one hand, and engages into the groove, on the other hand, after the pane has been placed at its destination on the building.

The sealing matter of the rim connection has material properties which assure a safe hold and seat of the fixation element in the groove formed in the rim connection, on the one hand, and prevent unacceptable high tensions from being introduced into the insulating glass unit by the fixation element, on the other hand. This can be for example realized in that due to a certain elasticity of the sealing matter tensions are buffered within the sealing matter and are not transferred to the panes of the insulating glass unit. The system according to the invention advantageously enables a fixation of glazings at buildings with high safety standards, such that additional fixation elements or safety systems are not necessary.

It is especially advantageous if the fixation element positively engages into the grove of the rim connection. According to an especially preferred embodiment of the invention, this one presents an undercut, behind which the fixation element engages. Such a groove assures a safe and firm seat of the fixation element, whereby an unintended disengagement of the fixation element is avoided, on the one hand, whereas a simple and fast possibility of mounting and eventually necessary dismounting of the fixation element is given, on the other hand. Thanks to the safe and firm seat of the fixation element within the groove, a use of additional fixation means is not required. The mounting of the system according to the invention is thus as largely simplified as possible and can be, in case of need, carried out without using supplementary auxiliary means, such as adhesive and tools.

According to another embodiment of the invention, the fixation element is a longitudinal profile element. The length of the profile element preferably corresponds to the side length of the insulating glass unit to be fixed, such that the fixation element assures a safe fixation of the insulating glass unit over the entire side length, if it is correctly mounted, and simultaneously seals the gap present between insulating glass unit and building against penetration of gross contaminations. It is of course also possible that several fixation elements having a short length can be used, of which one or more are placed on each side of the insulating glass unit for the fixation thereof. The use of several short fixation elements advantageously improves the handling thereof during mounting.

According to an especially advantageous embodiment of the invention the fixation element is a spring element. Due to the spring effect, a simple mounting is assured, wherein a compensation of small alignment mistakes is made possible. Preferably, the fixation element is a formed stainless steel sheet metal, which due to its mechanical properties allows a permanent and stable fixation and is highly suitable for a fixation of insulating glass units at buildings due to its positive weight/strength ratio and its corrosion resistance.

The fixation element is preferably formed such that it has a head portion, which engages in the groove formed in the rim connection of the insulating glass unit. According to an especially advantageous embodiment, the head portion is formed by a portion of the fixation element that has a rhombic curved cross section. Such a formed head portion has an inherent stability that avoids plastic deformations and is formed corresponding to the undercut of the groove, such that a safe hold is assured. Due to the rhombic shape of the head portion, there are no sharp material edges which could hurt an installer during the fixation of the insulating glass unit.

According to another embodiment of the invention, a frame unit is mounted on the building or the like, which frame unit preferably consists of profile elements made of aluminium or stainless steel. The frame unit advantageously comprises a groove that runs in parallel to the side faces of the insulating glass unit, and in which the fixation elements engage that also engage in the groove of the rim connection of the insulating glass unit. For this purpose, the fixation elements comprise a preferably hook-shaped curved resilient portion on their side opposite the insulating glass unit. It goes without saying that the groove formed in the frame unit has a shape corresponding to the shape of the used fixation elements and can both run continuously over the entire side length of the insulating glass unit and be realized by several openings having a corresponding form.

According to an especially advantageous embodiment of the invention, a sealing element is placed between the frame unit and the insulating glass unit. The sealing element is preferably made of an elastic material and serves for sealing the gap present between the frame unit and the insulating glass unit against the building interior. With regard to its dimensions and material properties, the sealing element is selected such that it prestresses the insulating glass unit against the fixation element. It is preferably formed such that when being duly mounted between the insulating glass unit and the frame unit it wedges with these ones if the seat is correct, such that an unintended disengagement will be efficiently prevented.

The groove is formed with a certain overdimension with respect to the head of the fixation element, so that the fixation element can be introduced into the groove provided in the rim connection in a simple manner and preferably without additional auxiliary means. According to another embodiment of the invention, the hollow space that remains between the fixation element and the rim connection due to this overdimension is sealed by means of a preferably elastic sealing material. In this way, humidity is prevented from penetrating into the groove and from there into the clearance between fixation element, insulating glass unit and frame unit. Furthermore, the sealing material serves as supplementary safety measure which also assures the long-term hold of the fixation means within the groove of the rim connection.

An especially advantageous embodiment of the invention is wherein a gap present between fixation element and frame unit is sealed by means of a sealing profile. The use of such a sealing profile is especially advantageous if instead of a fixation element that is formed as a continuous profile element, several short fixation elements are used, such that there is no seal between the insulating glass unit and the frame unit on the building outside. The sealing profile can be made of any suitable material, but preferably it is made of a weathering resistant plastic. The sealing profile can be fixed in a simple and fast manner during the mounting of the insulating glass unit on the building, preferably without additional fixation means and without the use of tools. For this purpose, a special embodiment of the invention provides that the sealing profile is placed in the frame unit by means of a locking element that engages in a groove of the frame unit. The locking element is formed as a clip connection and has locking projections which cooperate with corresponding undercuts of the groove and which assure a firm and permanent placement of the sealing profile in the frame unit. According to another embodiment of the invention, the sealing profile comprises another locking element which engages into a hollow space of the fixation element. This locking element is similar to the above mentioned locking element for the fixation on the frame unit and is preferably placed at the end of the sealing profile that is opposite this previously mentioned locking element. The fact that the sealing profile is fixed at the frame unit on the one hand and at the fixation element on the other hand makes it unnecessary to provide further structures or measures at the insulating glass unit itself which serve for the fixation of such a sealing profile. According to an especially elegant solution, the hollow space of the fixation element, into which the sealing profile engages, is placed in the head portion of the fixation element, which head portion is extremely suitable for such a reception due to the anyhow hollow form thereof if the fixation element consists of a curved band material.

An especially advantageous embodiment of the invention provides that the sealing profile, if duly placed, comprises a sealing lip on its side opposite the fixation element. This sealing lip serves for a sealing against an adjacent glazing unit or building structure. In this way it is assured that not only the joint between insulating glass unit and frame structure is sealed, but also a sealing of adjacent insulating glass units against each other or a sealing of an insulating glass unit against adjacent building structures is assured. The sealing lip is preferably placed in the end region of the sealing profile facing the outside of the building, such that an as far sealing as possible on the building outside is assured. In order to promote a safe seat of the sealing profile, another embodiment of the invention provides that the sealing profile comprises a spring element on its side opposite the frame unit. This spring element serves as a support with respect to an adjacent glazing unit or building structure. The sealing profile is preferably formed such that, in case of a duly mounted sealing profile, both the spring element and the sealing lip cooperate with spring elements or sealing lips of adjacent sealing profiles and thus obtain a mutual support as well as a mutual sealing.

The use of an above mentioned sealing profile does not only allow an especially simple and safe sealing, but also permits a highly flexible use of the system according to the invention, provided that it is assured that building structures adjacent to the glazing unit are also provided with means for receiving such sealing profiles. The system according to the invention thus enables a nearly arbitrary combination of insulating glass units with other insulating glass units or other building structures, such that an individual applicability of insulating glass units corresponding to the respective building architecture is possible.

The system according to the invention advantageously permits an exchangeable fixation of insulating glass units at buildings without the use of additional fixation means, such as screws, rivets, conglutinations etc. or special tools being required. Glazings that are fixed by means of the system according to the invention advantageously comprise joints between adjacent glazing units that only have a small joint width. The special design of the sealing profiles permits to combine the system according to the invention with glazing systems known from the state of the art in a simple manner.

### BRIEF DESCRIPTION OF THE DRAWINGS

Other advantages and characteristics of the present invention will become apparent in the following exemplary description of an especially preferred embodiment by means of the figures in which:

FIG. 1 is a schematic sectional view of the system according to the invention,

FIG. 2 shows two adjacent insulating glass units that are mounted using the system according to the invention from FIG. 1, and

FIG. 3 shows an insulating glass unit mounted by means of the system according to the invention in combination with an insulating glass unit mounted according to the state of the art.

### DESCRIPTION OF THE PREFERRED EMBODIMENT

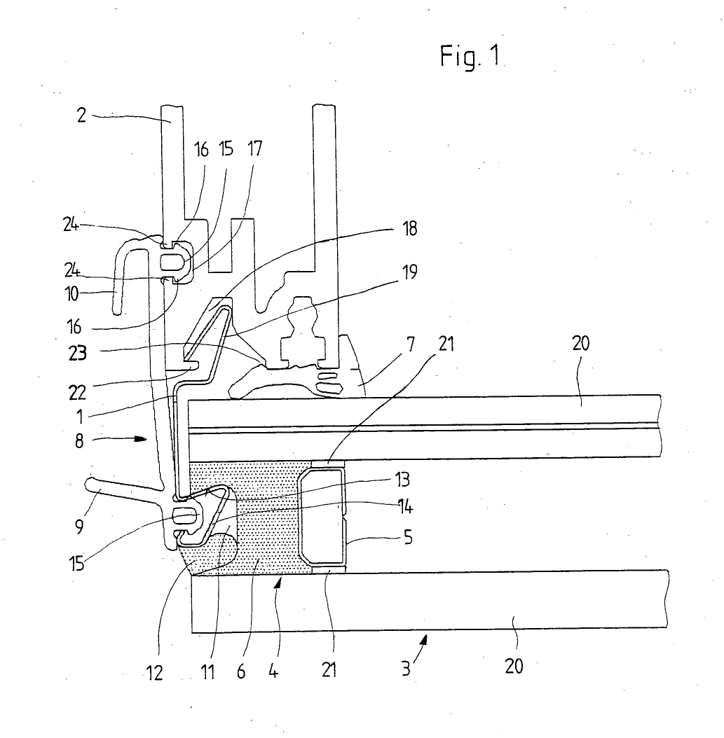

The insulating glass unit 3 represented in FIG. 1 is placed on a profile frame unit 2, which in turn is connected to the building to be glazed. The profile frame unit 2 consists of profile elements sufficiently known from the state of the art and preferably made of metal, which divert the weights of the glazing and of the dynamic loads acting thereon, such as wind loads, into the carrying structure of the building.

The insulating glass unit 3 is a unit which is also known in the state of the art and which comprises two panes 20, which are connected to each other by means of a rim connection 4. The rim connection 4 essentially consists of an aluminium profile 5 and a sealant 6 placed outside this aluminium profile 5. Between the aluminium profile 5 and the panes 20, a primary seal 21 is respectively arranged on both sides of the aluminium profile 5, which primary seal is for example an all around closed butyl cord which has been extruded on the aluminium profile 5. The primary seal 21 serves as water vapour and gas diffusion barrier and thus it is its primary object to protect the insulating glass unit against a penetration of air humidity and an escape of gas. The sealant 6 placed outside the aluminium profile 5 is a secondary seal which forms a permanent connection of the two panes 20 on the one hand by forming a chemical compound with the glass surfaces at the rim of the panes 20 and which closes the insulating glass unit in an air or gas tight manner on the other hand.

On the side of the rim of the insulating glass unit, a groove 11 is formed in the sealant 6. The groove 11 includes an undercut 13 on its side facing the building. The groove is formed in the rim connection 4 during the manufacture of the insulating glass unit 3 by the manufacturer thereof.

The insulating glass unit 3 is mounted on the profile frame unit by means of a fixation element 1. In the represented exemplary embodiment, the fixation element 1 is made of stainless steel and is bent as a continuous profile element transverse to the drawing plane. Due to its form and its material properties, the fixation element 1 acts as a spring. The fixation element 1 comprises a bent head portion 14 at its end facing the insulating glass unit 3, which head portion has an essentially rhombic cross section. The head portion 14 is shaped corresponding to the undercut 13 of the groove 11 and hooks into it when the fixation element 1 is duly mounted.

At its end opposite the head portion 14, the fixation element 1 is bent to form a spring snap 19, which engages in a groove 18 provided in the profile frame unit 2. For the safe reception of the spring snap 19, the groove 18 includes a projection 22 which hooks the spring snap 19.

On the inner side of the building an inner seal 7 is provided between the insulating glass unit 3 and the profile frame unit 2. This inner seal is a commercially available sealing profile which hooks with the profile frame unit by means of locking structures 23 formed corresponding to the shape of the profile frame unit 2, such that a safe seat in the gap present between the insulating glass unit 3 and the profile frame unit 2 is assured. The inner seal 7 and the fixation element 1 are adapted to each other such that with a mounted inner seal 7 the insulating glass unit 3 is tensioned with respect to the fixation element 1 such that the safe hold thereof is assured.

On the side opposite the inner seal 7, a sealing profile 8 is arranged. The sealing profile 8 serves for sealing the outer face of the clearance between the profile frame unit 2 and the insulating glass unit 3. The sealing profile 8 is made of any suitable sealing material, preferable of plastic. It comprises holding devices 15 on its side facing the insulating glass unit 3 or the profile frame unit 2. The sealing profile 8 continuously covers the entire side length of the insulating glass unit 3, such that the safe sealing thereof is assured over the entire length. The holding devices are also continuous holding structures covering the entire length of the sealing profile 8, but can alternatively be several spaced holding cams. The holding device 15 on the side of the building engages in a groove 17 provided in the profile frame unit 2. In order to assure a safe and permanent seat of the holding device 15 in this groove 17, the holding device includes locking cams 16 which engage behind corresponding projections 24 of the groove 17. The holding device 15 of the sealing profile 8 on the outside of the building engages in the bent head portion 14 of the fixation element 1. This holding device 15 also includes locking cams 16 which engage behind the rim side structures of the hollow head portion 14.

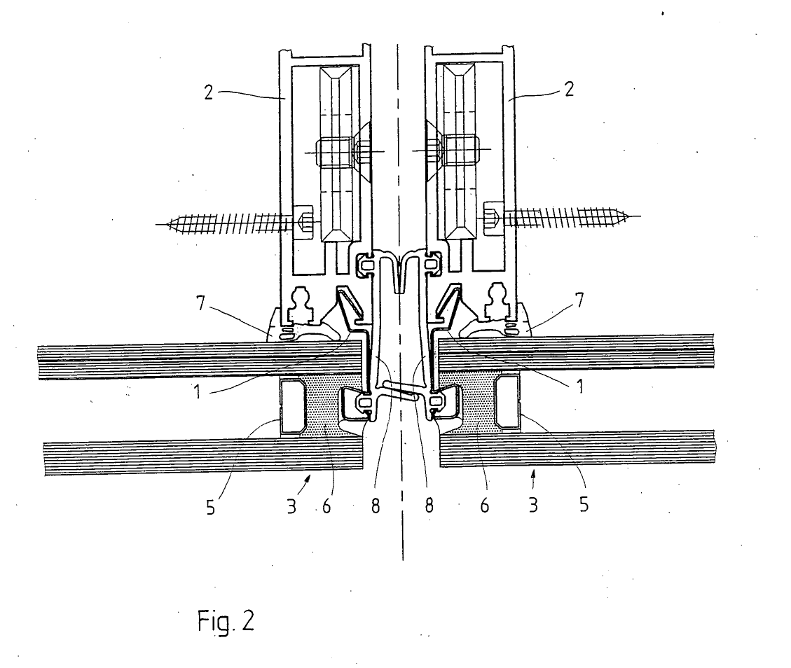

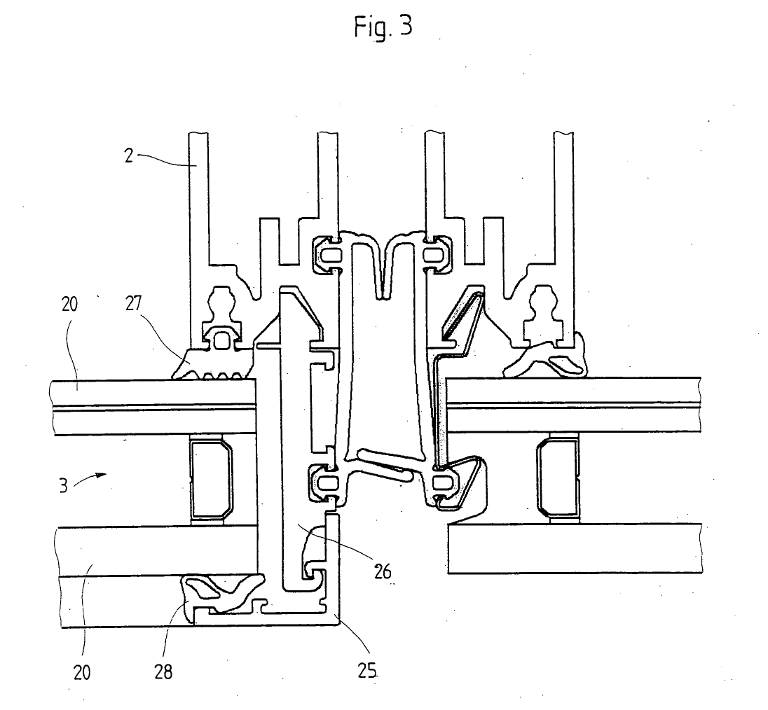

On the side opposite the insulating glass unit 3 and the profile frame unit 2, the sealing profile 8 has a sealing lip 9 on the building outside. On the inner side of the building, the sealing profile 8 is provided with a spring element 10. The function of sealing lip 9 and spring element 10 results from FIG. 2 as well as from FIG. 3, in which it is visible that the sealing lip 9 of a first sealing profile 8 cooperates with a sealing lip 9 of another sealing profile 8 of an adjacent insulating glass unit 3 and seals the gap between the insulating glass units 3. The spring elements 10 provided on the inner side of the building support each other, such that a safe hold of the adjacent sealing profiles 8 in the grooves 17 of the profile frame units 2 is assured.

In order to improve the hold of the fixation element 1 in the groove 11 of the rim connection 4, the space that remains between this one and the sealant 6 after insertion of the head portion 14 is sealed by means of a groove seal 12. The groove seal 12 prevents water or humidity from penetrating into the groove 11, from moving through the clearance between fixation element 1 and sealant 6 and thus from getting into the clearance between the fixation element 1, the insulating glass unit 3 and the profile frame unit 2. Furthermore, the groove seal 12 assures the seat of the head portion 14 in the groove 11. After the system according to the invention has been mounted, the groove seal 12 is realized by introducing a silicone sealant in a known way by means of a spray gun.

FIG. 3 shows the system according to the invention for the fixation of a glazing unit in combination with a glazing system known in the state of the art. The glazing system known from the state of the art—represented in FIG. 3 on the left side of the drawing—is composed of an insulating glass unit 3, which is fixed at the building by means of glass ledges 11 visible from outside and made of aluminium or stainless steel and insulation webs 10 using a same profile frame unit 2 and additional inner seals 27 and outer seals 28. A sealing profile 8 is arranged on the insulation web 26 as well as on the profile frame unit 2 in the above described manner. The sealing lips 9 and spring elements 10 of the two sealing profiles 8 adjacent to each other cooperate in the above described manner.

What is claimed is:

1. A system for the preferably frameless fixation of an insulating glass unit (3) comprising two panes (20) connected to each other by means of a rim connection (4) at buildings or the like wherein the insulating glass unit (3) is mounted on the building by means of a fixation element (1) that engages into a groove (11) formed in the rim connection (4) of the insulating glass unit (3).

2. A system according to claim 1, wherein the fixation element (1) positively engages in the groove (11).

3. A system according to claim 1, wherein the groove (11) formed in the rim connection (4) of the insulating glass unit (3) comprises an undercut (13), behind which the fixation element (1) engages.

4. A system according to claim 1, wherein the fixation element (1) is a longitudinal profile element.

5. A system according to one claim 1, wherein the fixation element (1) is a spring element.

6. A system according to claim 1, wherein the fixation element (1) is a formed stainless steel sheet.

7. A system according to claim 1, wherein the fixation element (1) has a head portion (14) which engages in the groove (11) formed in the rim connection (4) of the insulating glass unit (3).

8. A system according to claim 7, wherein the head portion (14) is a curved portion having a rhombic cross section of the fixation element (1).

9. A system according to claim 1, wherein a frame unit (2) is mounted on the building or the like.

10. A system according to claim 9, wherein the frame unit is made of aluminium or stainless steel.

11. A system according to claim 9, wherein the frame unit (2) consists of profile elements.

12. A system according to claim 9, wherein the fixation element (1) engages in a groove (18) of the frame unit (2).

13. A system according to claim 9, wherein the fixation element (1) engages in the groove (18) of the frame unit (2) with a hook-shaped resilient portion (19).

14. A system according to claim 9, wherein a sealing element (7) is placed between the frame unit (2) and the insulating glass unit (3).

15. A system according to claim 14, wherein the sealing element (7) seals the gap present between said frame unit (2) and said insulating glass unit (3) preferably against the building interior.

16. A system according to claim 14, wherein the sealing element (7) prestresses the insulating glass unit (3) against the fixation element (1).

17. A system according to claim 1, wherein a hollow space that remains between the fixation element (1) and the rim connection (4) is sealed by a preferably elastic sealant (12).

18. A system according to claim 9, wherein a gap between said fixation element (1) and said frame unit (2) is sealed by means of a sealing profile (8).

19. A system according to claim 18, wherein the sealing profile (8) is placed in a groove (17) of the frame unit (2) by means of a locking element (15) engaging in said groove.

20. A system according to claim 18, wherein the sealing profile (8) comprises a locking element (15) which engages in a hollow space of the fixation element (1).

21. A system according to claim 20, wherein the hollow space is placed in the head portion (14) of the fixation element (1) that engages in the rim connection (4).

22. A system according to claim 18, wherein the sealing profile (8), if duly mounted, comprises a sealing lip (9) on the side opposite the fixation element (1), which sealing lip serves for sealing against an adjacent glazing unit or building structure.

23. A system according to claim 18, wherein the sealing profile (8) comprises a spring element (10) on its side opposite the frame unit (2), which spring element serves as support with respect to an adjacent glazing unit or building structure.
